(19) United States
(12) Patent Application Publication
(10) Pub. No.: US 2025/0167340 A1
(43) Pub. Date: May 22, 2025

(54) RECHARGEABLE ENERGY STORAGE SYSTEM (RESS) INCLUDING A COLD PLATE HAVING AN INTEGRATED VENT

(71) Applicant: GM Global Technology Operations LLC, Detroit, MI (US)

(72) Inventors: Lawrence Xavier Lanier, SR., Farmington Hills, MI (US); Aaron Sussman, Keego Harbor, MI (US); Sara Arendell, Waterford, MI (US)

(21) Appl. No.: 18/514,433

(22) Filed: Nov. 20, 2023

(51) Int. Cl. H01M 10/6555; H01M 10/613; H01M 10/625; H01M 10/6556; H01M 10/6566

(52) U.S. Cl. CPC H01M 10/6555; H01M 10/613; H01M 10/625; H01M 10/6556; H01M 10/6566; H01M 2220/20

(57) ABSTRACT

A battery assembly includes a housing having a base wall and a plurality of side walls that collectively define an interior zone. A plurality of battery cells is arranged in the interior zone. A heat exchange member is arranged between the base wall and the plurality of battery cells. The heat exchange member includes a plurality of coolant fluid channels that pass a coolant fluid in heat exchange contact with the plurality of battery cells and a plurality of vent gas channels fluidically connected to the plurality of battery cells.

### INTRODUCTION

The subject disclosure relates to vehicles, and more particularly, to a rechargeable energy storage system (RESS) including having a cold plate having an integrated vent.

Many newer vehicles are being manufactured with electric propulsion systems. The electric propulsion system, be it a full electric system or a hybrid electric system, relies on an electric motor that is powered by energy stored in a rechargeable energy storage system (RESS) or battery. While in operation, the battery generates heat. The heat detracts from battery efficiency. In order to reduce heat produced by the battery, many vehicles include a cooling system that circulates a coolant fluid that is in thermal contact with the battery.

In some cases, the cooling system includes a plate arranged in a battery housing. Battery cells rest upon the plate. A coolant fluid passes through the plate in a heat exchange relationship with the battery cells. In addition to cooling, battery assemblies include a vent system that directs gases from the battery housing. Gases produced in the battery cells are directed through ducts that exit from the housing. Battery cells, cooling, venting, and power control systems take up space in a battery assembly. Requirements to add additional systems into the vehicle drive a need to reduce component footprints. Accordingly, it is desirable to integrated components in order to create space that can accommodate additional systems.

### SUMMARY

A battery assembly, in accordance with a non-limiting example, includes a housing having a base wall and a plurality of side walls that collectively define an interior zone. A plurality of battery cells is arranged in the interior zone. A heat exchange member is arranged between the base wall and the plurality of battery cells. The heat exchange member includes a plurality of coolant fluid channels that pass a coolant fluid in heat exchange contact with the plurality of battery cells and a plurality of vent gas channels fluidically connected to the plurality of battery cells.

In addition to one or more of the features described herein each of the plurality of coolant fluid channels include a first end, a second end, and an intermediate portion, the plurality of coolant fluid channels extending along an axis of the heat exchange member.

In addition to one or more of the features described herein each of the plurality of vent gas channels includes a first end portion, a second end portion, and an intermediate section, the plurality of vent gas channels extending along the axis of the heat exchange member.

In addition to one or more of the features described herein each of the plurality of vent gas channels are arranged between adjacent ones of the plurality of coolant fluid channels.

In addition to one or more of the features described herein a dam member extends across the heat exchange member substantially perpendicular to the plurality of coolant fluid channels and the plurality of vent gas channels, the dam member including a first end segment, a second end segment, and an intermediate segment that closes off the second end portion of each of the plurality of vent gas channels.

In addition to one or more of the features described herein the dam member includes an internal flow channel fluidically connecting the second end of each of the plurality of coolant fluid channels.

In addition to one or more of the features described herein a coolant fluid inlet is fluidically connected to one of the plurality of coolant fluid channels and the first end of the dam member and a coolant fluid outlet fluidically connected to another of the plurality of coolant fluid channels and the second end of the dam member.

In addition to one or more of the features described herein a vent gas collection member extends across the heat exchange member substantially perpendicular to the plurality of coolant fluid channels and the plurality of vent gas channels, the vent gas collection member fluidically connecting the first end portion of each of the plurality of vent gas channels to a sensor housing.

In addition to one or more of the features described herein the vent gas collection member includes a vent gas collection channel including a first channel portion that extends across the heat exchange member, a second channel portion that extends along the axis, and a third channel portion that extends across the heat exchange member, the third channel portion including a sensor housing.

In addition to one or more of the features described herein the vent gas collection member includes an internal coolant fluid channel that fluidically connects each of the plurality of coolant fluid channels.

A vehicle, in accordance with a non-limiting example, includes a body, a plurality of wheels connected to the body, an electric drive unit supported in the body and operatively connected to at least one of the plurality of wheels, and a battery assembly operatively connected to the electric drive unit. The battery assembly includes a housing having a base wall and a plurality of side walls that collectively define an interior zone. A plurality of battery cells is arranged in the interior zone. A heat exchange member is arranged between the base wall and the plurality of battery cells. The heat exchange member includes a plurality of coolant fluid channels that pass a coolant fluid in heat exchange contact with the plurality of battery cells and a plurality of vent gas channels fluidically connected to the plurality of battery cells.

In addition to one or more of the features described herein each of the plurality of coolant fluid channels include a first end, a second end, and an intermediate portion, the plurality of coolant fluid channels extending along an axis of the heat exchange member.

In addition to one or more of the features described herein each of the plurality of vent gas channels includes a first end portion, a second end portion, and an intermediate section, the plurality of vent gas channels extending along the axis of the heat exchange member.

In addition to one or more of the features described herein each of the plurality of vent gas channels are arranged between adjacent ones of the plurality of coolant fluid channels.

In addition to one or more of the features described herein a dam member extends across the heat exchange member substantially perpendicular to the plurality of coolant fluid channels and the plurality of vent gas channels, the dam member including a first end segment, a second end segment, and an intermediate segment that closes off the second end portion of each of the plurality of vent gas channels.

In addition to one or more of the features described herein the dam member includes an internal flow channel fluidically connecting the second end of each of the plurality of coolant fluid channels.

In addition to one or more of the features described herein a coolant fluid inlet is fluidically connected to one of the plurality of coolant fluid channels and the first end of the dam member and a coolant fluid outlet fluidically connected to another of the plurality of coolant fluid channels and the second end of the dam member.

In addition to one or more of the features described herein a vent gas collection member extends across the heat exchange member substantially perpendicular to the plurality of coolant fluid channels and the plurality of vent gas channels, the vent gas collection member fluidically connecting the first end portion of each of the plurality of vent gas channels to a sensor housing.

In addition to one or more of the features described herein the vent gas collection member includes a vent gas collection channel including a first channel portion that extends across the heat exchange member, a second channel portion that extends along the axis, and a third channel portion that extends across the heat exchange member, the third channel portion including a sensor housing.

In addition to one or more of the features described herein the vent gas collection member includes an internal coolant fluid channel that fluidically connects each of the plurality of coolant fluid channels.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a left side view of a vehicle including a rechargeable energy storage system (RESS) having a cold plate including an integrated vent, in accordance with a non-limiting example;

FIG. 2 is a partial perspective view of a battery assembly having a cold plate including an integrated vent, in accordance with a non-limiting example;

FIG. 3 is a top view of the cold plate including an integrated vent of FIG. 2, in accordance with a non-limiting example;

FIG. 4 is a cross-sectional perspective view of the cold plate including an integrated vent supporting battery cells, in accordance with a non-limiting example;

FIG. 5 is a perspective rear view showing a dam member mounted to the cold plate, in accordance with a non-limiting example;

FIG. 6 is perspective front view showing a vent gas collection member mounted to the cold plate, in accordance with a non-limiting example;

FIG. 7 is an upper right perspective view of the cold plate and dam member, in accordance with a non-limiting example; and

FIG. 8 is a top view of the vent gas collection member, in accordance with a non-limiting example.

### DETAILED DESCRIPTION

The following description is merely exemplary in nature and is not intended to limit the present disclosure, its application or uses. It should be understood that throughout the drawings, corresponding reference numerals indicate like or corresponding parts and features.

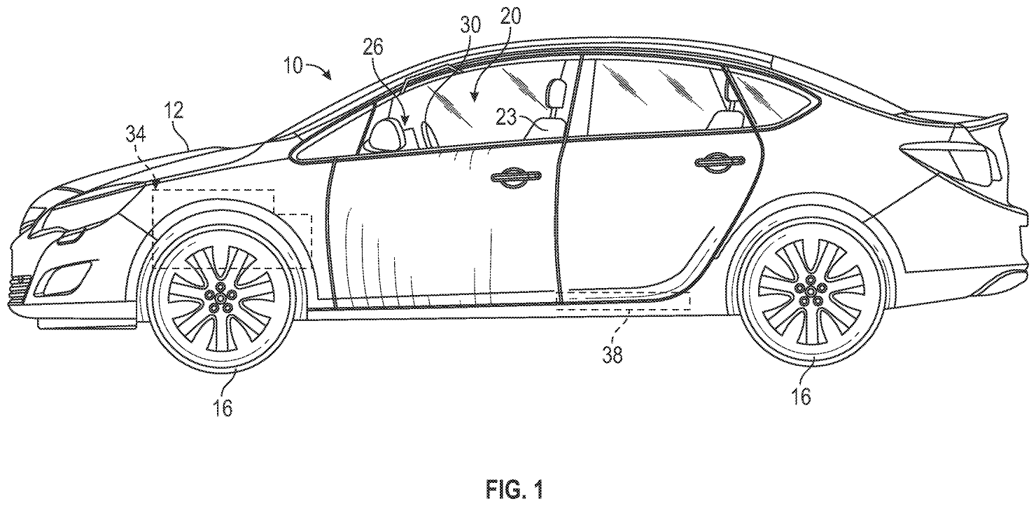

A vehicle, in accordance with a non-limiting example, is indicated generally at 10 in FIG. 1. Vehicle 10 includes a body 12 supported on a plurality of wheels 16. Body 12 defines, in part, a passenger compartment 20 having seats 23 positioned behind a dashboard 26. A steering control 30 is arranged between seats 23 and dashboard 26. Steering control 30 is operated to control orientation of select ones of the plurality of wheels 16. Vehicle 10 includes an electric drive unit 34 that provides power to one or more of the plurality of wheels 16.

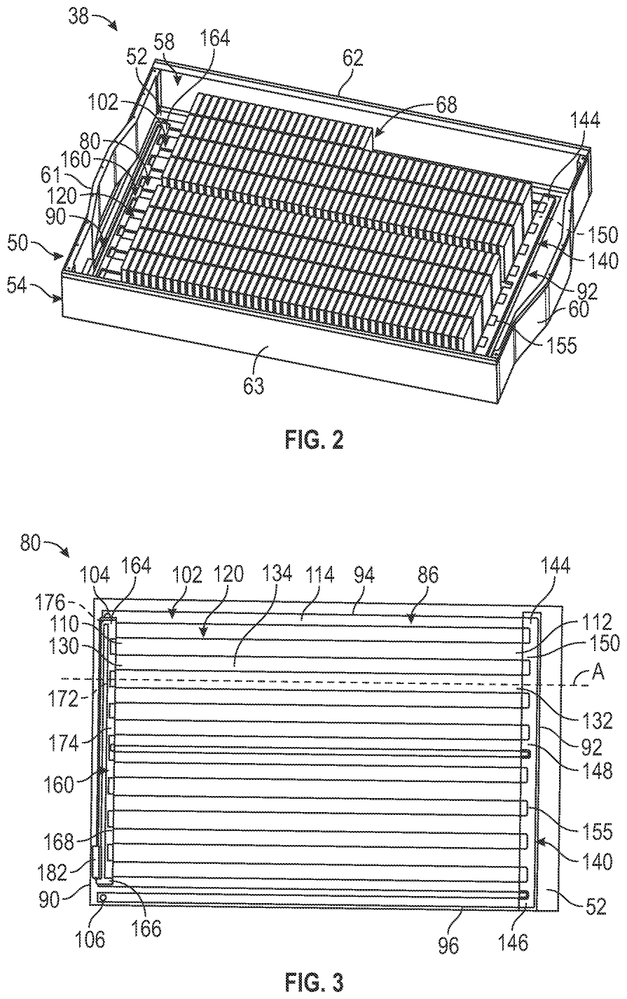

A rechargeable energy storage system (RESS) or battery assembly 38 is arranged in body 12 and provides power to electric drive unit 34. In other arrangements, a fuel cell (not shown) may be used to provide power to electric drive unit 34. At this point, it should be understood that the location of electric drive unit 34 and battery assembly 38 may vary. As shown in FIG. 2, battery assembly 38 includes a housing 50 having a base wall 52, and a plurality of side walls 54 that collectively define an interior zone 58. The plurality of side walls 54 include a first side wall 60, a second side wall 61, a third side wall 62, and a fourth side wall 63. A plurality of battery cells 68 is arranged in interior zone 58 of housing 50.

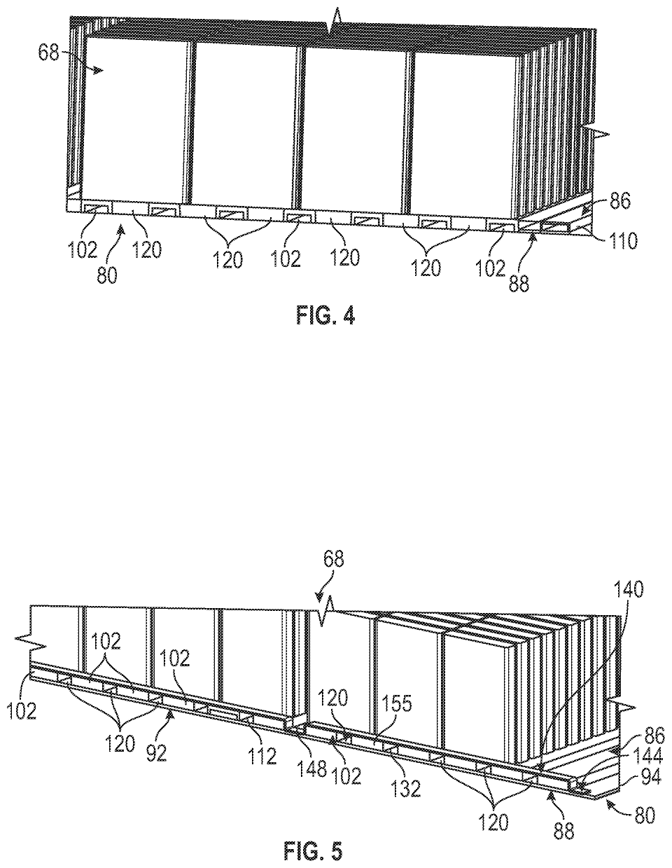

In a non-limiting example, a heat exchange member or cold plate 80 supports the plurality of battery cells 68 on base 52. Referring to FIGS. 3 and 4, cold plate 80 includes a first surface 86 and a second surface 88 that is opposite first surface 86. First surface 86 and second surface 88 are bounded by a first edge 90, a second edge 92, a first side edge 94 and a second side edge 96. An axis “A” of cold plate 80 extends between first edge 90 and second edge 92.

In a non-limiting example, cold plate 80 includes a plurality of coolant fluid channels, one of which is indicated at 102 extending between first surface 86 and second surface 88 substantially parallel to axis “A”. The plurality of coolant fluid channels 102 includes a coolant fluid inlet 104 arranged adjacent to first edge 90 at first side edge 94 and a coolant fluid outlet 106 arranged adjacent to first edge 90 at second side edge 96. The particular location of each of the coolant fluid inlet 104 and the coolant fluid outlet 106 may vary. Each of the plurality of coolant fluid channels 102 define closed conduits that carry a heat absorbing fluid in a heat exchange relationship with the plurality of battery cells 68. Coolant fluid channels 102 include a first end 110 at first edge 90, a second end 112 at second edge 92, and an intermediate portion 114 extending between first end 110 and second end 112. In the exemplary embodiment shown, coolant fluid channels 102 are spaced one from another.

In a non-limiting example, in addition to coolant fluid channels 102, cold plate 80 includes a plurality of gas venting channels 120 extending between first edge 90 and second edge 92 substantially parallel to axis “A”. Gas venting channels 120 take the form of recesses formed in first surface 86. In a non-limiting example, each of the gas venting channels 120 includes a first end portion 130 positioned near first edge 90, a second end portion 132 positioned near second edge 92, and an intermediate section 134 extending between first end portion 130 and second end portion 132. In a non-limiting example, second end portion 130 is closed off by a dam member 140.

In a non-limiting example, dam member 140, as shown in FIGS. 3 and 5, extends across first surface 86 between first side edge 94 and second side edge 96 at second edge 92. Dam member 140 includes a first end segment 144 positioned at first side edge 94, a second end segment 146 positioned at second side edge 96, and an intermediate segment 148 extending between first end segment 144 and second end segment 146. An internal flow channel 150 fluidically connected to each of the plurality of coolant fluid channels 102 at second end 112 passed through intermediate segment 148. Internal flow channel 150 promotes circulation of coolant fluid, such as water, through coolant fluid channels 102 between coolant fluid inlet 104 and coolant fluid outlet 106.

In a non-limiting example, dam member 140 also includes a plurality of dam elements 155 that close off second end portion 132 of each of the plurality of gas venting channels 120. In this manner, gas that may exit one or more of the plurality of battery cells 68 is prevented from exiting at second end portion 132 and is thus forced to flow toward first end portion 130 where it may be collected and sampled.

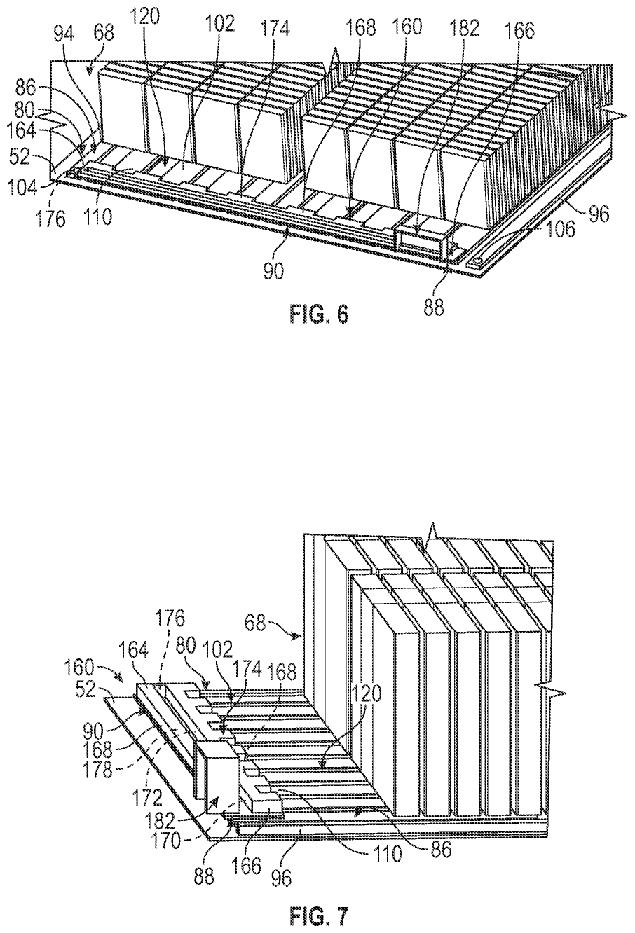

In a non-limiting example, cold plate 80 includes a vent gas collection member 160 arranged across first edge 90 on first surface 86 as shown in FIGS. 3, 6, 7 and 8. Vent gas collection member 160 includes a first edge portion 164 arranged at first side edge 94, a second edge portion 166 arranged at second side edge 96. Vent gas collection member 160 includes an internal coolant fluid channel 168 that fluidically connects with each of the plurality of coolant fluid channels 102 and a vent gas collection channel 170 running between first edge portion 164 and second edge portion 166. Vent gas collection channel 170 includes a first channel portion 172 including a plurality of gas inlets 174 fluidically connected to each of the plurality of vent gas channels 120. First channel portion 172 extends along first edge 90 substantially perpendicularly relative to axis “A”.

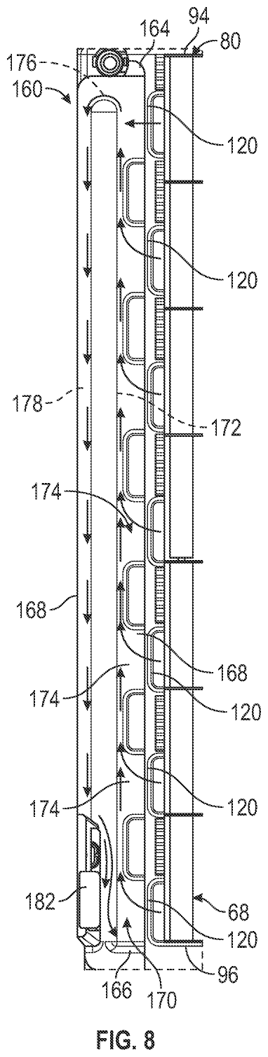

In a non-limiting example shown in FIG. 8, a second channel portion 176 extends from first channel portion 172 adjacent to first side edge 94. Second channel portion 176 extends substantially parallel to axis “A”. Vent gas collection channel 169 further includes a third channel portion 178 fluidically connected with and extending from second vent gas channel portion 172 to second side edge 96. Third vent gas channel portion 178 extends substantially perpendicularly relative to axis “A”. A sensor housing or gas collection chamber 182 is fluidically connected to third channel portion 178 at second edge 92. Sensor housing 182 may support a sensor (not shown) that samples gases passing from the plurality of battery cells 68. The geometry of vent gas collection channel 170 ensures that gases passing from the plurality of vent gas channels 120 are given an opportunity to cool before being sampled.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A battery assembly comprising:
a housing including a base wall and a plurality of side walls that collectively define an interior zone;
a plurality of battery cells arranged in the interior zone; and
a heat exchange member arranged between the base wall and the plurality of battery cells, the heat exchange member including a plurality of coolant fluid channels that pass a coolant fluid in heat exchange contact with the plurality of battery cells and a plurality of vent gas channels fluidically connected to the plurality of battery cells.

2. The battery assembly according to claim 1, wherein each of the plurality of coolant fluid channels include a first end, a second end, and an intermediate portion, the plurality of coolant fluid channels extending along an axis of the heat exchange member.

3. The battery assembly according to claim 2, wherein each of the plurality of vent gas channels includes a first end portion, a second end portion, and an intermediate section, the plurality of vent gas channels extending along the axis of the heat exchange member.

4. The battery assembly according to claim 3, wherein each of the plurality of vent gas channels are arranged between adjacent ones of the plurality of coolant fluid channels.

5. The battery assembly according to claim 3, further comprising a dam member extending across the heat exchange member substantially perpendicular to the plurality of coolant fluid channels and the plurality of vent gas channels, the dam member including a first end segment, a second end segment, and an intermediate segment that closes off the second end portion of each of the plurality of vent gas channels.

6. The battery assembly according to claim 5, wherein the dam member includes an internal flow channel fluidically connecting the second end of each of the plurality of coolant fluid channels.

7. The battery assembly according to claim 5, further comprising a coolant fluid inlet fluidically connected to one of the plurality of coolant fluid channels and the first end of the dam member and a coolant fluid outlet fluidically connected to another of the plurality of coolant fluid channels and the second end of the dam member.

8. The battery assembly according to claim 5, further comprising a vent gas collection member extending across the heat exchange member substantially perpendicular to the plurality of coolant fluid channels and the plurality of vent gas channels, the vent gas collection member fluidically connecting the first end portion of each of the plurality of vent gas channels to a sensor housing.

9. The battery assembly according to claim 8, wherein the vent gas collection member includes a vent gas collection channel including a first channel portion that extends across the heat exchange member, a second channel portion that extends along the axis, and a third channel portion that extends across the heat exchange member, the third channel portion including a sensor housing.

10. The battery assembly according to claim 8, wherein the vent gas collection member includes an internal coolant fluid channel that fluidically connects each of the plurality of coolant fluid channels.

11. A vehicle comprising:
a body;
a plurality of wheels connected to the body;
an electric drive unit supported in the body and operatively connected to at least one of the plurality of wheels; and
a battery assembly operatively connected to the electric drive unit, the battery assembly comprising:
a housing including a base wall and a plurality of side walls that collectively define an interior zone;
a plurality of battery cells arranged in the interior zone; and
a heat exchange member arranged between the base wall and the plurality of battery cells, the heat exchange member including a plurality of coolant fluid channels that pass a coolant fluid in heat exchange contact with the plurality of battery cells and a plurality of vent gas channels fluidically connected to the plurality of battery cells.

12. The vehicle according to claim 11, wherein each of the plurality of coolant fluid channels include a first end, a second end, and an intermediate portion, the plurality of coolant fluid channels extending along an axis of the heat exchange member.

13. The vehicle according to claim 12, wherein each of the plurality of vent gas channels includes a first end portion, a second end portion, and an intermediate section, the plurality of vent gas channels extending along the axis of the heat exchange member.

14. The vehicle according to claim 13, wherein each of the plurality of vent gas channels are arranged between adjacent ones of the plurality of coolant fluid channels.

15. The vehicle according to claim 13, further comprising a dam member extending across the heat exchange member substantially perpendicular to the plurality of coolant fluid channels and the plurality of vent gas channels, the dam member including a first end segment, a second end segment, and an intermediate segment that closes off the second end portion of each of the plurality of vent gas channels.

16. The vehicle according to claim 15, wherein the dam member includes an internal flow channel fluidically connecting the second end of each of the plurality of coolant fluid channels.

17. The vehicle according to claim 15, further comprising a coolant fluid inlet fluidically connected to one of the plurality of coolant fluid channels and the first end of the dam member and a coolant fluid outlet fluidically connected to another of the plurality of coolant fluid channels and the second end of the dam member.

18. The vehicle according to claim 15, further comprising a vent gas collection member extending across the heat exchange member substantially perpendicular to the plurality of coolant fluid channels and the plurality of vent gas channels, the vent gas collection member fluidically connecting the first end portion of each of the plurality of vent gas channels to a sensor housing.

19. The vehicle according to claim 18, wherein the vent gas collection member includes a vent gas collection channel including a first channel portion that extends across the heat exchange member, a second channel portion that extends along the axis, and a third channel portion that extends across the heat exchange member, the third channel portion including a sensor housing.

20. The vehicle according to claim 18, wherein the vent gas collection member includes an internal coolant fluid channel that fluidically connects each of the plurality of coolant fluid channels.
